(19) United States
(12) Patent Application Publication
(10) Pub. No.: US 2008/0199659 A1
(43) Pub. Date: Aug. 21, 2008

(54) TRANSPARENT HYDROPHOBIC ARTICLE HAVING SELF-CLEANING AND LIQUID REPELLANT FEATURES AND METHOD OF FABRICATING SAME

(75) Inventor: YANG ZHAO, Novi, MI (US)

Correspondence Address: BRINKS HOFER GILSON & LIONE, P.O. BOX 10395, CHICAGO, IL, 60610, US

(73) Assignee: WAYNE STATE UNIVERSITY, DETROIT, MI (US)

(21) Appl. No.: 12/050,807

(22) Filed: Mar. 18, 2008

Related U.S. Application Data
(63) Continuation of application No. PCT/US2006/036187, filed on Sep. 15, 2006.
(60) Provisional application No. 60/718,587, filed on Sep. 19, 2005.

(51) Int. Cl. B32B 33/00; B32B 3/30; B05D 5/08

(52) U.S. Cl. 428/161; 427/164; 427/165

(57) ABSTRACT

A transparent hydrophobic article having self-cleaning and liquid repellent features is disclosed. The article comprises a transparent substrate comprising a subwavelength structured surface including arrays of protuberances. Each protuberance has a predetermined distance to its adjacent neighbor and a predetermined height to minimize light diffraction and random scattering therethrough. The article further comprises a hydrophobic material disposed on the subwavelength structured surface. The hydrophobic material has a predetermined thickness and a predetermined hydrophobicity for self-cleaning and repelling from fluids thereon.

### CROSS-REFERENCE TO RELATED APPLICATIONS

This application is a continuation of International Application No. PCT/US2006/036187 filed on Sep. 15, 2006, entitled “TRANSPARENT HYDROPHOBIC ARTICLE HAVING SELF-CLEANING AND LIQUID REPELLANT FEATURES AND METHOD OF FABRICATING SAME” and claims the benefit of U.S. Provisional Application Ser. No. 60/718,587 filed on Sep. 19, 2005, entitled “TRANSPARENT HYDROPHOBIC ARTICLE HAVING SELF-CLEANING AND LIQUID REPELLANT FEATURES AND METHOD OF FABRICATING SAME,” the entire contents of each are incorporated herein by reference.

### BACKGROUND OF THE INVENTION

The present invention relates to transparent hydrophobic articles with self-cleaning and liquid repellent properties.

The ability to repel liquid from solid surfaces is needed and is continually being improved for various industrial applications. For example, liquid repellency may be used to prevent adhesion of moisture and ice from vehicle windows, to aid in self-cleaning of indicators (e.g., traffic light indicators), to reduce clotting in artificial blood vessels, or to enhance stain-resistant features on textiles. Hydrophobicity can be observed in nature on the leaves of sacred lotus. The surfaces of such leaves have micrometer-scale roughness, resulting in water contact angles of up to 170°, since air trapped between the droplets and the wax crystals at the plant surface minimizes the contact area. Surfaces having water contact angles greater than about 140° may be considered hydrophobic. However, such surfaces of materials are not optically transparent due to diffraction scattering and since their surfaces have micrometer-scale roughness.

Thus, there is a need for articles having transparent hydrophobic surfaces for apparatus such as optical sensors, mirrors, cameras, and eyeglasses to name a few.

### BRIEF SUMMARY OF THE INVENTION

The present invention provides a transparent hydrophobic article having a surface that repels liquid therefrom. The present invention further provides a method for fabricating the transparent hydrophobic article having self-cleaning and liquid repellent properties.

In one embodiment, the article comprises a transparent substrate comprising a subwavelength structured surface. The subwavelength structured surface includes a plurality of protuberances. Such protuberances have relatively similar shape and size, as well as a predetermined maximum distance between adjacent protuberances for a given range of wavelengths to minimize light diffraction and random light scattering therethrough. The article further comprises a hydrophobic material disposed on the subwavelength structured surface. The hydrophobic material has a predetermined thickness and a predetermined hydrophobicity for enhanced self-cleaning and repelling from fluids thereon.

In another example, the present invention provides a method of fabricating the transparent hydrophobic article. In this example, the method comprises providing an optically transparent substrate having a predetermined hydrophobicity. The method further comprises forming a nano-scale pattern on the surface of the substrate to define the subwavelength structured surface of the structure so that light diffraction and random light scattering is minimized from the transparent substrate.

Further objects, features, and advantages of the present invention will become apparent from consideration of the following description and the appended claims when taken in connection with the accompanying drawings.

### BRIEF DESCRIPTION OF THE DRAWINGS

FIG. 1 is an elevated side view of a transparent hydrophobic article having self-cleaning and liquid repellant features in accordance with one embodiment of the present invention;

FIG. 2 is an enlarged view of circle 2 in FIG. 1 of the transparent hydrophobic article;

FIG. 3 is a side view of a subwavelength structured surface of the transparent substrate depicting an incident angle in accordance with one embodiment of the present invention;

FIG. 4 is a flow chart depicting one method of fabricating the transparent hydrophobic article in accordance with one example of the present invention;

FIG. 5 is a flow chart depicting one method for fabricating the transparent hydrophobic article in accordance with another example of the present invention;

FIG. 6 is a perspective view of a transparent substrate patterned by nanosphere lithography in accordance with the example depicted in the flow chart of FIG. 5; and

FIG. 7 is a perspective view of the transparent substrate having grown nanorods thereon in accordance with the example depicted in the flow chart of FIG. 5.

### DETAILED DESCRIPTION OF THE INVENTION

The present invention generally provides a transparent hydrophobic article having self-cleaning and liquid repellant properties. The transparent hydrophobic article may be used for enhanced liquid repellency to prevent adhesion of moisture and ice from the surfaces of vehicle windows, to aid in self-cleaning of the surfaces of indicators, to reduce clotting on the inner walls of artificial blood vessels, and to enhance stain-resistant properties on surfaces of textiles. In one embodiment, the article comprises a transparent substrate having a subwavelength structured surface including arrays of protuberances. The article further comprises a hydrophobic material disposed on the surface to enhance the article with an apparent contact angle of between about 120 and 170 degrees for enhanced liquid repellency from the substrate.

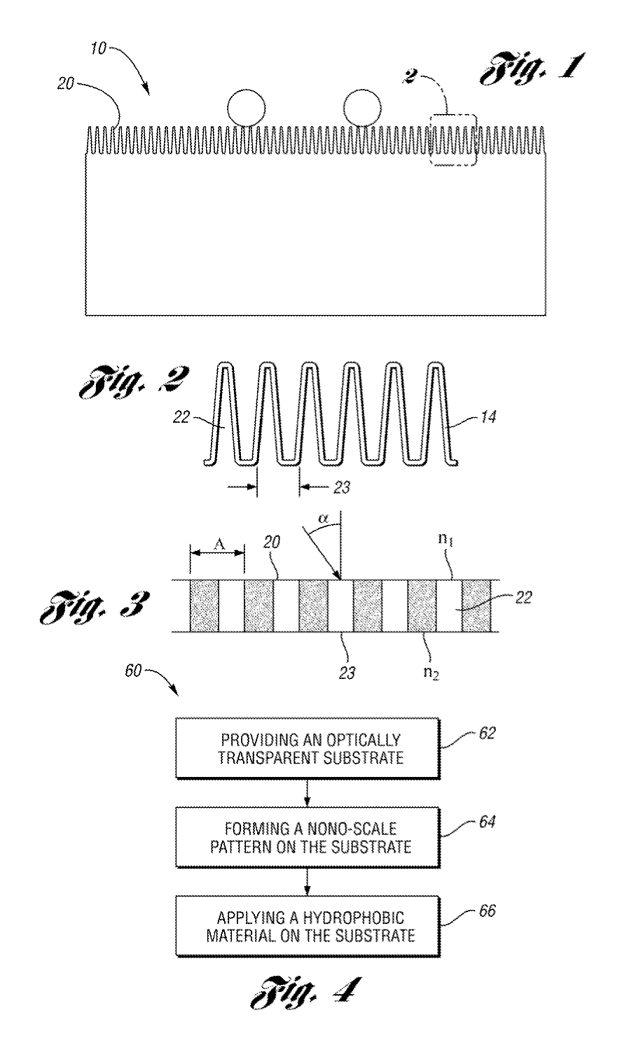

FIGS. 1 and 2 illustrate a transparent hydrophobic article 10 having self-cleaning and liquid repellant properties in accordance with one embodiment of the present invention. As shown, the article 10 comprises a transparent substrate 12 and a hydrophobic material 14 disposed on the transparent substrate 10. In this embodiment, the transparent substrate 10 comprises a subwavelength structured surface 20 including a plurality of protuberances 22 formed thereon. As depicted, the subwavelength structured surface 20 is relatively rough formed or corrugated. In this embodiment, each protuberance includes a base and tapers to an end. Each protuberance may take on a number of shapes including conical, cylindrical, or tapered shapes with an arcuate or a pointed end without falling beyond the scope or spirit of the present invention.

Preferably, each protuberance 22 has a predetermined maximum distance 23 to the adjacent neighbor for a given range of operation wavelengths. Such properties function to minimize light diffraction and random light scattering therethrough to define the transparent and hydrophobic properties of the transparent substrate 12. Preferably, the predetermined distance 23 is less than the predetermined height of each of the protuberances 22 on the subwavelength structured surface 20.

In this embodiment, the predetermined maximum distance between two adjacent protuberances of the transparent substrate 12 may be up to about 500 nm. The distance between two adjacent protuberances may be between about 50 nanometers (nm) and 500 nm, preferably between about 100 nm and 400 nm, and most preferably about 300 nm for visible wavelengths. The predetermined height of protuberances of the substrate 12 may range between about 100 nm and 2 micron, preferably between about 300 nm and 1 micron, and most preferably about 500 nm.

In this embodiment, the transparent substrate 12 further comprises a predetermined hydrophobicity that is defined by an apparent contact angle observed on the subwavelength structured surface 20 when liquid is in contact thereon. The contact angle may be represented in an equation that represents the relation between the apparent contact angle observed on a relatively rough surface and an equilibrium contact angle on a relatively smooth surface of the same composition. The contact angle may be represented by the following equation:

cos θ*=−1+φₛ(cos θ+1) (A)

wherein θ* is the apparent contact angle, the θ represents the equilibrium contact angle, and φₛ represents the surface fraction corresponding to the ratio of the subwavelength structured surface in contact with liquid. Thus, as the value of φₛ approaches 0, the value of θ* approaches 180 degrees. In this embodiment, the apparent contact angle of the subwavelength structured surface is between about 100 and 175 degrees, preferably between about 120 and 175 degrees, and most preferably between 140 and 175 degrees.

In one embodiment, the transparent substrate 12 may comprise any suitable transparent material such as glass, high density polyethylene, polypropylene, polyvinyl chloride (PVC), quartz, ITO, diamond or any transparent dielectric, or a mixture thereof.

As mentioned above, in this embodiment, the transparent hydrophobic article 10 further comprises the hydrophobic material 14 applied on the subwavelength structured surface 20. The hydrophobicity of the subwavelength structured surface 20 may be enhanced by the hydrophobic material 14 by chemical modification that affects or lowers the surface energy to “superhydrophobic” levels, i.e., an apparent contact angle of greater than about 120 degrees. A superhydrophobicity on a surface results from the increase of the surface roughness to such an apparent contact angle.

Preferably, the hydrophobic material 14 has a predetermined thickness and a predetermined hydrophobicity to provide enhanced self-cleaning and repelling properties from fluids on the surface of the transparent substrate 12. In one embodiment, the predetermined thickness of the hydrophobic material 14 is between about 10 nm and 300 nm, preferably between about 50 nm and 200 nm, and most preferably about 100 nm.

Preferably, the hydrophobic material 14 may comprise any suitable hydrophobic component such as polytetrafluoroethylene (PTFE or also know as Teflon™), silicone, paraffin wax, isotactic polypropylene, or polystyrene, or a mixture thereof.

Referring now to FIG. 3 of the drawings, in this embodiment, the subwavelength structured surface 20 is a first surface on which the hydrophobic material 14 is disposed. The predetermined maximum distance between two adjacent protuberances 22 may be defined as:

Λ<λ/[max(n₁,n₂)+n₁ sin(α)],

wherein λ represents the incident (operation) wavelength and Λ represents the distance between two adjacent protuberances thereof, and argument n₁ represent the refractive index of the medium above first surface 20 and argument n₂ represents refractive index of the medium below the second surface 23 opposite the first surface, and wherein max represents the maximum of the arguments n₁ and n₂.

For example, if n₁=1 and n₂=1.5, λ=500 nm, and α=30 degrees, then Λ should be less than about 250 nm.

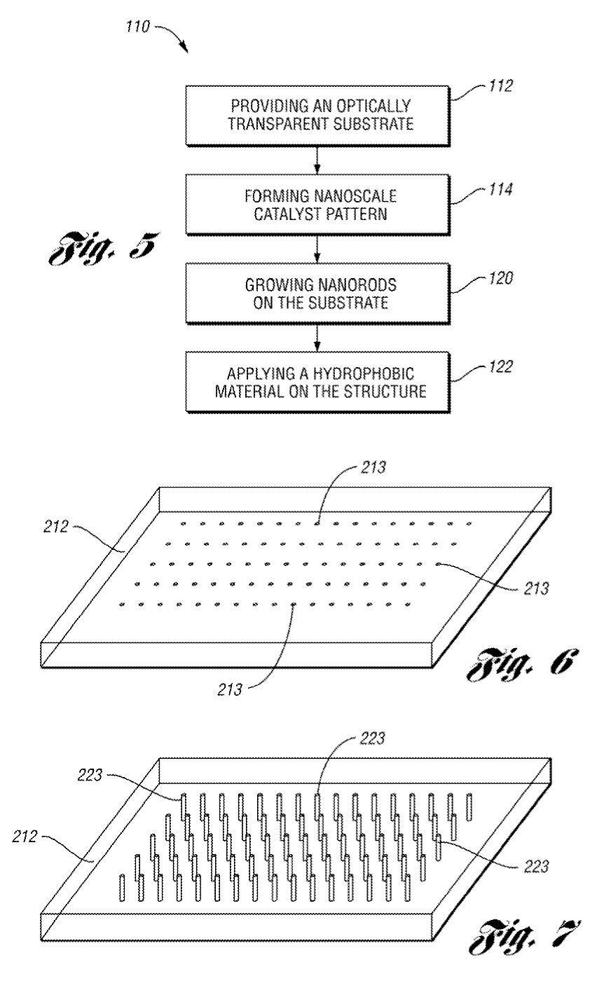

FIG. 4 depicts a flow chart of a method 60 for fabricating an optically transparent article having hydrophobic features in accordance with one example of the present invention. In one example, an optically transparent substrate has a predetermined transparency and hydrophobicity is provided in box 62. As mentioned above, the substrate may have a level of transparency and hydrophobicity as mentioned above, e.g., each protuberance may have a predetermined distance to its neighbor and a predetermined height, to minimize light diffraction and random light scattering through the substrate.

The method 60 further comprises forming, in box 64, a nano-scale pattern on the first surface of the transparent substrate to define the subwavelength structured surface of the transparent structure so that light diffraction and random light scattering through the substrate is minimized. Any suitable technique known in the art may be implemented to accomplish this. For example, the following techniques may be implemented: deep ultra-violet photolithography and etching; electron beam lithography and etching; nanosphere lithography and etching; and nano-imprinting.

In this example, the method 60 may further include applying or coating, in box 66, the subwavelength structured surface with a layer of hydrophobic material having a predetermined hydrophobicity. This may be accomplished by any suitable means such as spin-coating, evaporation coating, CVD, and dip coating. In this example, the coated layer is preferably hydrophobic materials that are optically transparent as discussed above.

It is to be noted that the hydrophobic material may only be applied onto the substrate where needed. For example, if the transparent substrate is determined to be “hydrophobic” or at a “hydrophobic” level, i.e., having an apparent contact angle of greater than about 100 degrees, then applying the hydrophobic material on the transparent substrate may be unwarranted.

In another example depicted in FIG. 5, a method 110 of fabricating an optically transparent article having hydrophobic features may be accomplished by way of using the growth of nanorods on a transparent substrate. In this example, the substrate is prepared with a catalyst layer combined with a surface epitaxial approach to ultimately grow an area of arrays of nanorods thereon. The fabrication or synthesis method comprises three steps. For example, patterned ZnO nanorod arrays are grown onto a transparent substrate, on which patterned catalyst spots are dispersed or deposited. In this example, an array of catalyst spots is formed on a single-crystal Al₂O₃ substrate by using nanosphere lithography. A Self-assembled monolayer is formed on the substrate and a thin layer of gold (Au) film is deposited on the monolayer. The spheres are then etched away to leave a patterned gold catalyst array. Finally, nanorods are grown on the substrate using a vapor-liquid-solid (VLS) process. Details on each step are described in greater detail below.

As depicted in FIG. 5, the method 110 of fabrication includes preparing the substrate in a predetermined pattern of catalyst thin layer using nanosphere lithography or photolithography, to provide in box 112 an optically transparent substrate. The method further comprises depositing a layer of seed particles, e.g., gold (Au) particles, onto the substrate and etching the nanospheres from the substrate to define a patterned gold catalyst array on the substrate to form a nanoscale catalyst pattern in box 114. The method further comprises forming or growing in box 120 nanorods on the substrate. This may be accomplished by any suitable means such as by a VLS process. The method further comprises applying the hydrophobic material on the fabricated surface with nanorods.

FIG. 6 illustrates a transparent substrate 212 prepared with a predetermined pattern, e.g., the patterned gold catalyst array in this example, the pattern is prepared using nanosphere lithography or photolithography. However, it is to be understood that any other suitable technique may be implemented to prepare the substrate, without falling beyond the scope or spirit of the present invention. The nanoscale spots 213 are covered by a thin layer of seed materials such as gold (Au) (e.g., 1-5 nm thick gold film for ZnO nanorods). The seed material acts as a catalyst on which nanorods can grow.

In forming the catalyst pattern using nanosphere lithography, an ordered monolayer of spheres is prepared by self-assembly. In this example, monodispersed polystyrene (PS) spheres suspensions may be obtained from Duke Scientific Corp. and used as received. For deposition, a predetermined sized single-crystal sapphire substrate may then be sonicated for about 20 minutes in about a 2% Hellmanex II solution followed by about a 3 hour anneal in air at about 1000° C. to achieve a relatively hydrophilic and atomically flat surface. Then, 2 or 3 drops of the PS sphere suspension is applied to the surface of the substrate. After holding the substrate 212 stationary for 1 minute to obtain dispersion of the suspension, the sapphire substrate is then immersed into deionized water. To prevent any further additions to the substrate is preferably kept immersed. Then, a few drops of 2% dodecylsodiumsulfate solution are added to the water to change the surface tension. As a result, the monolayer of PS spheres that remained suspended on the surface of the water is pushed aside due to the change in the surface tension. The substrate is then removed through the clear area where the surface tension of the water is modified by the surfactant, preventing any additional PS spheres from being deposited on the monolayer during its removal from the water. A metal frame may be used to support the sample above the water surface while the sample is sonicated to avoid clustering of the PS spheres during drying.

The self-assembled arrays of PS spheres are then used to pattern the catalyst to guide ZnO growth onto substrate. In this example, gold particles are either sputtered or thermally evaporated onto the self-assembled monolayer structure. As a result, two different usable patterns may be obtained. For the sputtered coatings, the high mobility of the gold atoms during the sputtering process results in gold covering every available area, even beneath the spheres. Therefore, after etching away the PS spheres using toluene, this technique produced a honeycomb-like hexagonal gold pattern. However, by using a thermal evaporator, which provides a line of sight vapor stream, the gold particles are only deposited onto areas of the substrate that were not shadowed by the PS spheres. After etching away the PS spheres, a highly ordered hexagonal array of gold spots is formed on the substrate.

Using the patterned catalyst, ZnO nanorods are grown by a solid-liquid-vapor process. The source materials preferably contain equal amounts (by weight) of ZnO powder and graphite powder, used to lower the growth temperature. The source materials are then ground together and loaded into an alumina boat that is placed at the center of an alumina tube with the substrate being positioned slightly downstream from the tube's center. Both ends of the tube are then water cooled to achieve a reasonable temperature gradient. A horizontal tube furnace is used to heat the tube to about 950° C. at a rate of about 50° C./min, and the temperature is held for between about 20 and 30 minutes under a pressure of between about 300 and 400 mbar at a constant argon flow at about 25 sccm. Then, the furnace is shut down and cooled to room temperature under a flow of argon.

As depicted in FIG. 7, a growth process of nanorods 223 from the substrate then occurs including a relatively aligned growth of the ZnO nanorods therefrom. The honeycomb-like arrangement of the gold pattern is preserved during the growth process. ZnO nanorods grown sideways may also be observed. A hexagonal arrangement of the aligned ZnO nanorods may also be observed. In this example, relatively all of the ZnO nanorods may have about the same height, of about 1.5 micron and their diameters range between about 50 and 150 nm. By changing the growth time, the height of the ZnO nanorods may be varied from a few hundred nanometers to a few micrometers. In this example, relatively most of the ZnO nanorods grow perpendicular relative to the substrate, but some may also grow parallel to the substrate, and have a growth root from the same catalyst particle that promotes vertical nanorod growth. Moreover, a ZnO nanorod may include a catalyst particle at the tip of the nanorod.

With the resulted ZnO nanorods of desired feature sizes and heights, the substrate is coated with a thin layer of the hydrophobic material as discussed above. In this example, the hydrophobic material may be dip-coated or spin-coated on the substrate. However, other techniques mentioned above may be used without falling beyond the scope or spirit of the present invention.

Further description of one method of making a transparent substrate of the present invention may be found in “Large-Scale Hexagonal-Patterned Growth of Aligned ZnO Nanorods for Nano-optoelectronics and Nanosensor Arrays,” Nano Letters, Vol. 4, No. 3 (2004), Xudong Wang et al., the entire contents of which are incorporated herein by reference.

While the present invention has been described in terms of preferred embodiments, it will be understood, of course, that the invention is not limited thereto since modifications may be made to those skilled in the art, particularly in light of the foregoing teachings.

1. A transparent hydrophobic article having self-cleaning and liquid repellent features, the article comprising:
a transparent substrate comprising a subwavelength structured surface including arrays of protuberances, each protuberance having a predetermined maximum distance between each protuberance and a predetermined height to minimize light diffraction and random scattering therethrough; and
a hydrophobic material disposed on the subwavelength structured surface, the hydrophobic material having a predetermined thickness and a predetermined hydrophobicity for self-cleaning and repelling from fluids thereon.

2. The article of claim 1 wherein the substrate comprises at least one of the following components: glass, high density polyethylene, polypropylene, polymeric material, polyvinyl chloride, quartz, transparent dielectric, or diamond, or a mixture thereof.

3. The article of claim 1 wherein the predetermined maximum distance about 500 nm.

4. The article of claim 1 wherein the predetermined height of the substrate is between about 100 nm and 2 micron.

5. The article of claim 1 wherein the substrate comprises a predetermined hydrophobicity is defined by the apparent contact angle observed on the subwavelength structured surface.

6. The article of claim 5 wherein the apparent contact angle is represented by:
cos θ*=−1+φₛ(cos θ+1),
wherein θ* is the apparent contact angle, θ represents the equilibrium contact angle, and φₛ represents the surface fraction corresponding to the ratio of the subwavelength structured surface in contact with liquid.

7. The article of claim 1 wherein the apparent contact angle of the subwavelength structured surface is between about 90 and 160 degrees.

8. The article of claim 1 wherein the apparent contact angle of the article with the hydrophobic material is between about 120 and 170 degrees.

9. The article of claim 1 wherein the predetermined thickness of the coating is up to about 300 nm.

10. The article of claim 1 wherein the hydrophobic material comprises polytetrafluoroethylene, silicone, paraffin wax, isotactic polypropylene, or polystyrene, or a mixture thereof.

11. The article of claim 1 wherein the subwavelength structured surface is a first surface on which the hydrophobic material is disposed and wherein the predetermined maximum distance is defined as:
Λ<λ/[max(n₁,n₂)+n₁ sin(α)],
wherein λ represents the incident wavelength and Λ represents the distance between two adjacent protuberances thereof,
wherein argument n₁ represent the refractive index of the medium above the first surface and argument n₂ represents refractive index of the medium below a second surface opposite the first surface, and
wherein max represents the maximum of the arguments.

12. A method of fabricating an optically transparent structure having hydrophobic features, the method comprising:
providing an optically transparent substrate having a predetermined hydrophobicity; and
forming a nano-scale pattern on the surface of the substrate to define a subwavelength structured surface of the structure so that light diffraction and random scattering is minimized from the structure, the subwavelength structured surface including arrays of protuberances, each protuberance having a predetermined maximum distance and a predetermined height to minimize light diffraction and random scattering therethrough.

13. The method of claim 12 further comprising:
coating the subwavelength structured surface with a layer of hydrophobic material having a predetermined hydrophobicity.

14. The method of claim 12 wherein the substrate comprises at lease one of the following components: glass, high density polyethylene, polypropylene, polymeric material, polyvinyl chloride, quartz, transparent dielectric, or diamond, or a mixture thereof.

15. The method of claim 12 wherein the predetermined maximum distance is about 500 nm.

16. The method of claim 12 wherein the predetermined height of protuberances of the substrate is between about 100 nm and 2 micron.

17. The method of claim 12 wherein the substrate comprises a predetermined hydrophobicity is defined by the apparent contact angle observed on the subwavelength structured surface.

18. The method of claim 17 wherein the apparent contact angle is represented by:
cos θ*=−1+φₛ(cos θ+1),
wherein θ* is the apparent contact angle, θ represents the equilibrium contact angle, and φₛ represents the surface fraction corresponding to the ratio of the subwavelength structured surface in contact with liquid.

19. The method of claim 12 wherein the apparent contact angle of the subwavelength structured surface is between about 90 and 160 degrees.

20. The method of claim 12 wherein the apparent contact angle of the method with the hydrophobic material is between about 120 and 170 degrees.

21. The method of claim 12 wherein the predetermined thickness of the coating is between about 10 nm and 300 nm.

22. The method of claim 12 wherein the hydrophobic material comprises polytetrafluoroethylene, silicone, paraffin wax, isotactic polypropylene, or polystyrene, or a mixture thereof.

23. The method of claim 12 wherein the subwavelength structured surface is a first surface on which the hydrophobic material is disposed and wherein the predetermined maximum distance is defined as:
Λ<λ/[max(n₁,n₂)+n₁ sin(α)],
wherein λ represents the wavelength of the incident light and Λ represents the distance between two adjacent protuberances thereof,
wherein argument n₁ represent the refractive index of the medium above first surface and argument n₂ represents refractive index of the medium below a second surface opposite the first surface, and
wherein max represents the maximum of the arguments.

24. A method of fabricating an optically transparent article having hydrophobic features, the method comprising:
preparing a predetermined nanoscale catalyst pattern on a first surface of a transparent substrate;
forming the nanoscale catalyst spots of the transparent substrate to form nanorods extending from the transparent substrate to define a subwavelength structured surface, each nanorod having a predetermined maximum distance between each nanorod and a predetermined height to minimize light diffraction and random scattering therethrough, wherein the predetermined maximum distance is defined as:
Λ<λ/[max(n₁,n₂)+n₁ sin(α)],
wherein λ represents the incident wavelength and Λ represents the distance between two adjacent nanorods thereof,
wherein argument n₁ represent the refractive index of the medium above the first surface and argument n₂ represents refractive index of the medium below a second surface opposite the first surface,
wherein max represents the maximum of the arguments; and
coating the subwavelength structured surface with a layer of hydrophobic material having a predetermined hydrophobicity to enhance the hydrophobicity of the article for self-cleaning and liquid repellent properties thereon.
